(19) United States
(12) Patent Application Publication
(10) Pub. No.: US 2022/0135219 A1
(43) Pub. Date: May 5, 2022

(54) DISTRIBUTED POWER-SPLIT ARCHITECTURE FOR EDRONE APPLICATIONS

(71) Applicant: GM Global Technology Operations LLC, Detroit, MI (US)

(72) Inventors: Venkata Prasad Atluri, Novi, MI (US); Venkatesh Gopalakrishnan, Troy, MI (US); Neeraj S. Shidore, Novi, MI (US); Chandra S. Namuduri, Troy, MI (US)

(21) Appl. No.: 17/084,967

(22) Filed: Oct. 30, 2020

(51) Int. Cl. B64C 39/02; B64D 27/24

(52) U.S. Cl. CPC B64C 39/024; B64D 27/24; B64D 2221/00; B64C 2201/027; B64C 2201/108; B64C 2201/042

(57) ABSTRACT

A system to distribute power in the operation of a drone vehicle includes a primary energy storage unit, a plurality of power boost modules that communicate electrically with the primary energy storage unit, and a plurality of propeller-motor modules, each of the plurality of propeller-motor modules being connected electrically to a respective power boost module of the plurality of power boost modules. One or more of the plurality of power boost modules provide on-demand additional energy to a respective propeller-motor module during the operation of the drone vehicle.

### INTRODUCTION

The present disclosure relates to power distribution to drones. More particularly, the present disclosure relates to a split architecture for power distribution to drones.

Current drones operate as motor vehicles to carry cargo and to provide imaging capabilities. Future drones will operate to carry human passengers. As such, these drones will have to operate to provide power redundancy and fault tolerance. That is, if there is a failure in any aspect of the drone, the drone will have the capability to continue to operate. Further, during certain aspects of the operation of the drone, extreme power demands are placed on the power architecture of the drone.

While current power architectures of drones achieve their intended purpose, there is a need for a new and improved power architectures that provide reliable operation of the drones.

### SUMMARY

According to several aspects, a system to distribute power in the operation of a drone vehicle includes a primary energy storage unit, a plurality of power boost modules that communicate electrically with the primary energy storage unit, and a plurality of propeller-motor modules, each of the plurality of propeller-motor modules being connected electrically to a respective power boost module of the plurality of power boost modules. One or more of the plurality of power boost modules provide on-demand additional energy to a respective propeller-motor module during the operation of the drone vehicle.

In an additional aspect of the present disclosure, one or more of the plurality of power boost modules is recharged during the operation of the drone vehicle.

In another aspect of the present disclosure, each of the plurality of propeller-motor modules includes a motor connected to a respective propeller.

In another aspect of the present disclosure, each of the plurality of propeller-motor modules includes an inverter.

In another aspect of the present disclosure, the motor and the inverter are an integrated unit for each of the propeller-motor modules.

In another aspect of the present disclosure, each of the plurality of power boost modules includes an ultra-capacitor and a dc-dc converter.

In another aspect of the present disclosure, each of the power boost modules and an associated propeller-motor module are an integrated unit.

In another aspect of the present disclosure, each of the plurality of power boost modules is operated independently of the primary storage unit.

In another aspect of the present disclosure, the primary storage unit is a battery pack.

In another aspect of the present disclosure, the primary storage unit is a plurality of battery packs.

According to several aspects, a drone includes a distributed power-split architecture with a primary energy storage unit, a plurality of power boost modules that communicate electrically with the primary energy storage unit, and a plurality of propeller-motor modules, each of the plurality of propeller-motor modules being connected electrically to a respective power boost module of the plurality of power boost modules. One or more of the plurality of power boost modules provide on-demand additional energy to a respective propeller-motor module during the operation of the drone vehicle. And one or more of the plurality of power boost modules is recharged during the operation of the drone vehicle.

In another aspect of the present disclosure, each of the plurality of propeller-motor modules includes a motor connected to a respective propeller and further includes an inverter.

In another aspect of the present disclosure, the motor and the inverter are an integrated unit for each of the propeller-motor modules.

In another aspect of the present disclosure, each of the plurality of power boost modules includes an ultra-capacitor and a dc-dc converter.

In another aspect of the present disclosure, each of the power boost modules and an associated propeller-motor module are an integrated unit.

In another aspect of the present disclosure, each of the plurality of power boost modules is operated independently of the primary storage unit.

In another aspect of the present disclosure, the primary storage unit is a battery pack.

In another aspect of the present disclosure, the primary storage unit is a plurality of battery packs.

According to several aspects, a drone includes a distributed power-split architecture with a primary energy storage unit, the primary energy storage unit being one or more battery packs, a plurality of power boost modules that communicate electrically with the primary energy storage unit, each of the plurality of power boost modules including an ultra-capacitor and a dc-dc converter, and a plurality of propeller-motor modules, each of the plurality of propeller-motor modules being connected electrically to a respective power boost module of the plurality of power boost modules, each of the plurality propeller-motor modules being an integrated unit including an inverter and a motor. One or more of the plurality of power boost modules provide on-demand additional energy to a respective propeller-motor module during the operation of the drone vehicle. And one or more of the plurality of power boost modules is recharged during the operation of the drone vehicle.

In another aspect of the present disclosure, each of the plurality of power boost modules is operated independently of the primary storage unit.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a drone vehicle with propeller modules according to an exemplary embodiment;

FIG. 2A is a schematic view of a power spilt architecture for the propeller modules according to an exemplary embodiment;

FIG. 2B is a schematic view of an individual propeller power module according to an exemplary embodiment;

FIG. 3 a graph of mission time versus load demand for a mission according to an exemplary embodiment;

FIG. 4 is a flow diagram for the operation of a power boost module of the propeller module during a boost mode according to an exemplary embodiment; and

FIG. 5 is a flow diagram for the operation of a power boost module of the propeller module during a charging mode according to an exemplary embodiment.

### DETAILED DESCRIPTION

The following description is merely exemplary in nature and is not intended to limit the present disclosure, application, or uses.

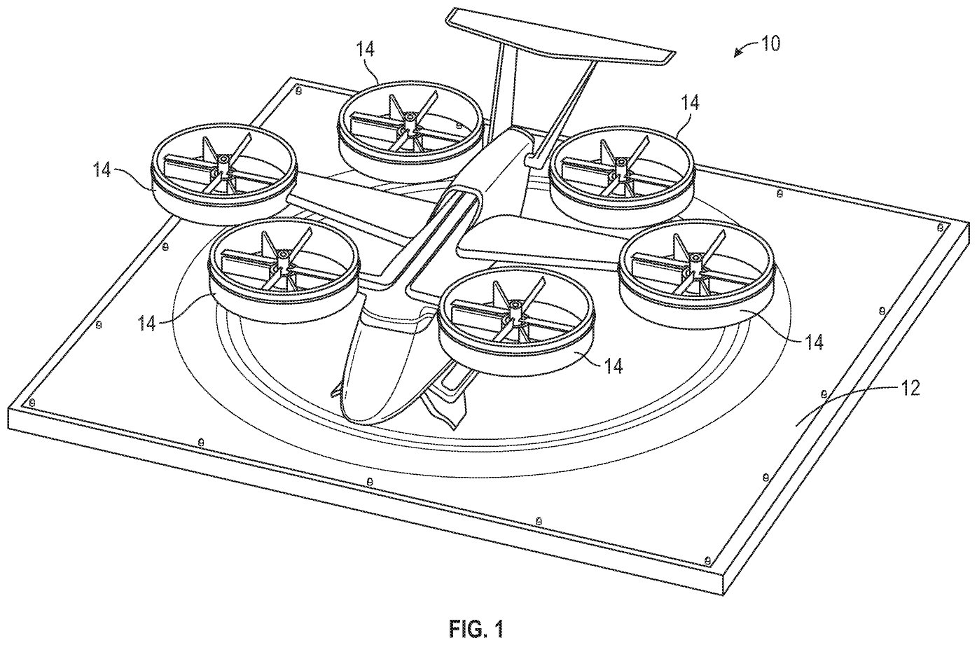

Referring to FIG. 1, there is shown a drone 10 situated on a landing pad 12. The drone 10 is configured to transport cargo and/or passengers. The drone in the present configuration incudes six propeller modules 14. In a particular arrangement, the drone 10 utilizes about 100 kWh for take-off, cruising and landing during the operation of the drone 10. In some arrangements, the drone 10 includes more than six propeller modules 14, while in other arrangements the drone 10 includes fewer than six propeller modules 14.

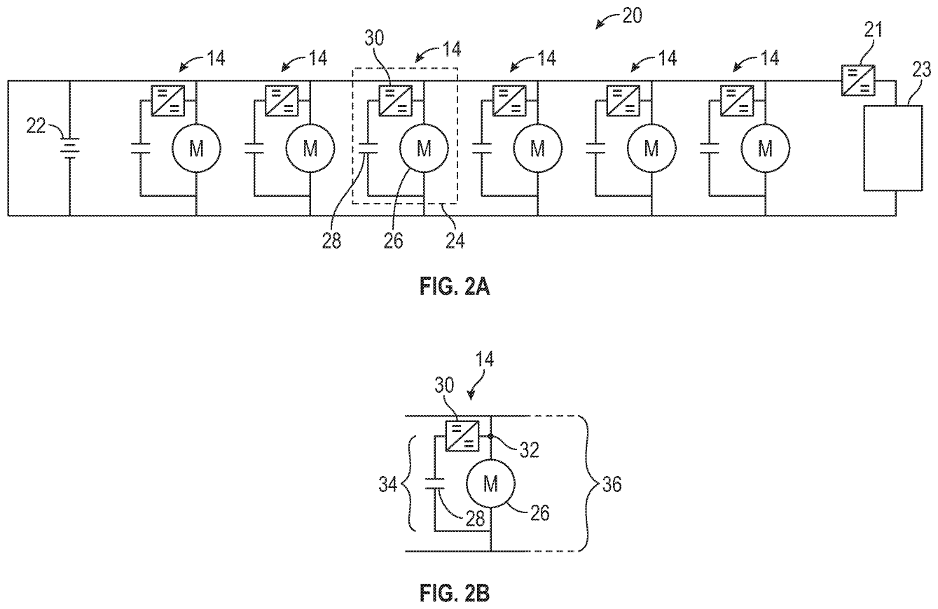

Referring now to FIG. 2A, there is shown a distributed power-split architecture 20 utilized to power the drone 10. The power-split architecture 20 includes a primary energy storage unit 22. The primary energy storage unit 22 is a single battery pack in some configurations, while in other configurations the primary storage unit 22 includes multiple battery packs. The power-split architecture includes a dc-dc converter 21 that regulates the power for the utilization of various accessories 23 in the drone 10.

Each propeller unit 14 includes a propeller-motor module 26 that is connected to a respective propeller. In various arrangements, each propeller-motor module 26 includes a motor that rotates the propeller and an inverter that converts dc to ac. In certain arrangements, the motor and the inverter in each propeller-motor module 26 is an integrated unit.

Each propeller unit 14 further includes a power boost module with an ultracapacitor 28 and a dc-dc converter 30. The ultracapacitor 28 provides secondary energy storage when a power boost is required for the operation of the propeller unit 14, for example, during takeoff, and the dc-dc converter 30 operates as a voltage regulator. In certain arrangements, the propeller-motor module 26, the ultracapacitor 28 and the dc-dc converter 30 are all integrated as a single unit.

The power boost modules are optimally sized with the ultracapacitor 28 and the dc-dc converter 30 for the operation of the drone 10. The power boost modules provide built-in power redundancy and multi-layer fault tolerance. The power boost modules further enable multi-rotor based flight controls, that is, the power boost modules are capable of operating individually without utilizing the primary energy storage unit. Moreover, the power boost modules enable lower disc loading to reduce propeller noise during takeoffs and landing.

Referring further to FIG. 2B, there is shown an individual propeller unit 14 identifying the primary voltage 36 supplied by the primary energy storage unit 22 and the secondary voltage 34 supplied by the ultracapacitor 28 and the dc-dc converter 30 of the power boost module, which supplies a dc 32 to the propeller-motor module 26. In turn, the inverter in the propeller-motor module 26 converts the dc to ac for the operation of the motor.

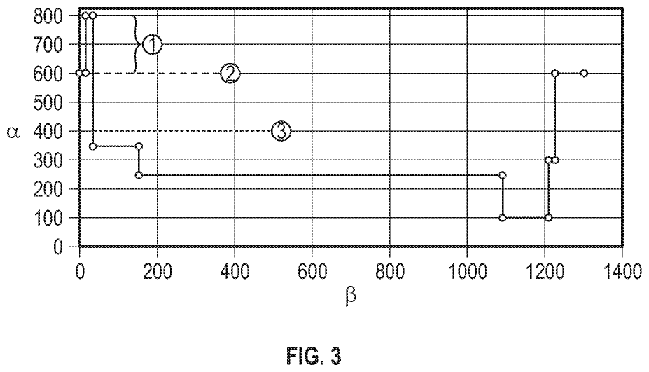

Referring to FIG. 3, there is shown an example of a mission for the drone 10 as total load demand, α (KW), as a function of mission time, β (sec). The mission is indicated by the small open circles from 0 to about 1300 sec. During the initial phase of the operation (1), such as, during takeoff, the total load demand, α, exceeds an upper power threshold (2). As such, the power boost module (ultracapacitor 28 and dc-dc converter 30) provides secondary power for the propeller-motor module 26.

At around 25 sec, the total load demand, α, falls below a lower power threshold (3). During the time between 25 sec and 1,200 sec, the power boost module is charged by the primary energy storage unit 22. During the landing phase (about 1,200 sec to about 1,300 sec), the load demand, α, does not exceed the upper power threshold (2), so that power from the power boost module is not required. In other missions, the total load demand, α, during landing exceeds the upper power threshold (2), so that the power boost module provides additional power to the propeller-motor module 26.

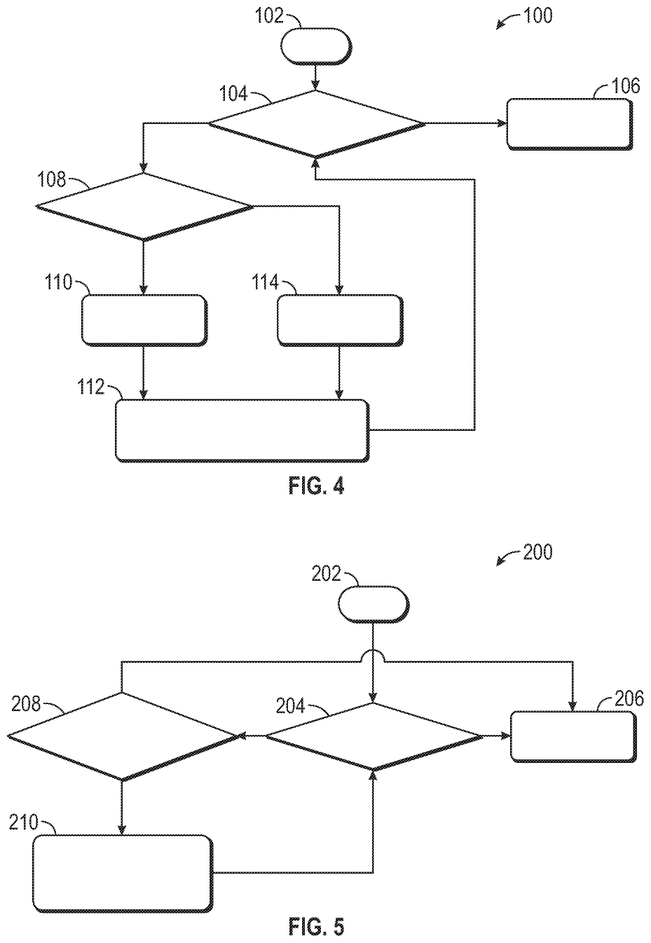

Referring now to FIG. 4, there is shown a flow diagram of a process 100 during a boost mode of operation of the power-split architecture 20. The process 100 starts at a step 102 and proceeds to a decision step 104, which decides if the power demand, α, exceeds the upper power threshold (2). If the power demand, α, does not exceed the upper power threshold (2), the process 100 proceeds to a step 106, where the dc-dc converters 30 are set in an idle mode.

If the power demand, α, exceeds the upper power threshold (2) in the step 104, the process 100 proceeds to a decision step 108, which determines if the voltage 34 from the power boost module is greater than the voltage 36 of the primary energy storage unit 22. If the secondary voltage 34 exceeds the primary voltage 36, the process proceeds to a step 110, which sets the dc-dc converter to a buck mode, that is, the dc-dc converter steps down the voltage 34 from the power boost module. If the secondary voltage 34 is not greater than the primary voltage 36, the process 100, in a step 114, sets the dc-dc converter 30 in a boost mode to step up the secondary voltage 34.

From either step 110 or 114, the process 100, in a step 112, the process controls the dc-dc converter 30 by setting the boost power equal to the product of the dc-dc output current 32 and the primary voltage 36. This information is then relayed back to the decision step 104.

Referring now to FIG. 5, there is shown a flow diagram of a process 200 during a trickle charge mode of operation of the power-split architecture 20. The process 200 starts at a step 202 and proceeds to a decision step 204, which decides if the power demand, α, is less than the lower power threshold (3). If the power demand, α, is not lower than the lower power threshold (3), the process 200 proceeds to a step 206, where the dc-dc converters 30 are set in an idle mode.

If the power demand, α, is less than the lower power threshold (3) in the step 204, the process 200 proceeds to a decision step 108, which determines if the secondary voltage 34 from the power boost module is less than a secondary voltage charge threshold. If the secondary voltage 34 is not less than the secondary voltage charge threshold, the process 200 returns back to the step 206. If the secondary voltage 34 is less than the secondary voltage charge threshold, the process 200, in a step 210, controls the dc-dc converter 30 to charge the secondary power boost module, namely, the ultracapacitor 28. The process 200 then returns to the step 204.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system to distribute power in the operation of a drone vehicle, the system comprising:
a primary energy storage unit;
a plurality of power boost modules that communicate electrically with the primary energy storage unit; and
a plurality of propeller-motor modules, each of the plurality of propeller-motor modules being connected electrically to a respective power boost module of the plurality of power boost modules,
wherein one or more of the plurality of power boost modules provide on-demand additional energy to a respective propeller-motor module during the operation of the drone vehicle.

2. The system of claim 1, wherein one or more of the plurality of power boost modules is recharged during the operation of the drone vehicle.

3. The system of claim 1, wherein each of the plurality of propeller-motor modules includes a motor connected to a respective propeller.

4. The system of claim 3, wherein each of the plurality of propeller-motor modules includes an inverter.

5. The system of claim 4, wherein the motor and the inverter are an integrated unit for each of the propeller-motor modules.

6. The system of claim 1, wherein each of the plurality of power boost modules includes an ultra-capacitor and a dc-dc converter.

7. The system of claim 1, wherein each of the power boost modules and an associated propeller-motor module are an integrated unit.

8. The system of claim 1, wherein each of the plurality of power boost modules is operated independently of the primary storage unit.

9. The system of claim 1, wherein the primary storage unit is a battery pack.

10. The system of claim 1, wherein the primary storage unit is a plurality of battery packs.

11. A drone comprising:
a distributed power-split architecture including:
a primary energy storage unit;
a plurality of power boost modules that communicate electrically with the primary energy storage unit; and
a plurality of propeller-motor modules, each of the plurality of propeller-motor modules being connected electrically to a respective power boost module of the plurality of power boost modules,
wherein one or more of the plurality of power boost modules provide on-demand additional energy to a respective propeller-motor module during the operation of the drone vehicle, and
wherein one or more of the plurality of power boost modules is recharged during the operation of the drone vehicle.

12. The drone of claim 11, wherein each of the plurality of propeller-motor modules includes a motor connected to a respective propeller and further includes an inverter.

13. The drone of claim 12, wherein the motor and the inverter are an integrated unit for each of the propeller-motor modules.

14. The drone of claim 11, wherein each of the plurality of power boost modules includes an ultra-capacitor and a dc-dc converter.

15. The drone of claim 11, wherein each of the power boost modules and an associated propeller-motor module are an integrated unit.

16. The drone of claim 11, wherein each of the plurality of power boost modules is operated independently of the primary storage unit.

17. The drone of claim 11, wherein the primary storage unit is a battery pack.

18. The drone of claim 11, wherein the primary storage unit is a plurality of battery packs.

19. A drone comprising:
a distributed power-split architecture including:
a primary energy storage unit, the primary energy storage unit being one or more battery packs;
a plurality of power boost modules that communicate electrically with the primary energy storage unit, each of the plurality of power boost modules including an ultra-capacitor and a dc-dc converter; and
a plurality of propeller-motor modules, each of the plurality of propeller-motor modules being connected electrically to a respective power boost module of the plurality of power boost modules, each of the plurality propeller-motor modules being an integrated unit including an inverter and a motor,
wherein one or more of the plurality of power boost modules provide on-demand additional energy to a respective propeller-motor module during the operation of the drone vehicle, and
wherein one or more of the plurality of power boost modules is recharged during the operation of the drone vehicle.

20. The drone of claim 19, wherein each of the plurality of power boost modules is operated independently of the primary storage unit.
